(19) United States
(12) Patent Application Publication
(10) Pub. No.: US 2020/0334890 A1
(43) Pub. Date: Oct. 22, 2020

(54) Systems and Methods for Fast Texture Mapping of 3D Models

(71) Applicant: University of Kentucky Research Foundation, Lexington, KY (US)

(72) Inventors: Wei LI, Nanjing (CN); Ruigang YANG, Lexington, KY (US)

(21) Appl. No.: 16/391,093

(22) Filed: Apr. 22, 2019

(51) Int. Cl. G06T 15/04; G06T 15/50

(52) U.S. Cl. CPC G06T 15/04; G06T 15/503

(57) ABSTRACT

A method for texturing an un-textured computer-generated or scanned 3D model that is a polygon mesh of a plurality of triangles is disclosed. A set of input images and the un-textured 3D model are provided to an image space optimization module, which determines texture coordinates for each triangle of the polygon mesh. Each texture coordinate associates the triangle with an area of a source image from the set of input images. Determining the texture coordinates includes locally optimizing the texture coordinates along texture seams, followed by globally optimizing the texture coordinates in each source image over the entire source image. A textured 3D model is generated from the determined texture coordinates after the local-then-global optimization.

### FIELD OF THE INVENTION

The disclosed invention relates generally to computer generated imaging, and more particularly to systems and methods for fast texture mapping of a triangular mesh model given a set of calibrated images.

### BACKGROUND OF THE INVENTION

With the wide availability of low cost commodity 3D full frame sensors, such as the Microsoft Kinect® and Intel RealSense® systems, it is becoming easier to capture 3D data. From the robust system of the KinectFusion® and large scale scanning to the more recent work related to the fusion of dynamic objects over space and time, good quality 3D models can be obtained even with a single handheld depth camera. These approaches typically utilize a volumetric representation of 3D geometry, with the final 3D model being mostly presented either as a white, textureless model, or as colored with simple per-vertex color.

A drawback of the per-vertex color approach is that, due to the high cost associated with generating a dense voxel grid, per-vertex colored models often appear blurry and with low resolution. It is therefore desirable that the 3D model be textured by 2D color images, which are typically more readily available at high quality. Many depth sensors indeed come with a color texture camera, and the resolution of a color camera is typically a few times higher than the resolution of the depth sensor.

But the image projection approach, which is the typical method of texturing a mesh model using 2D images, is not without its own shortcomings, as directly projecting the images onto the model has proved problematic. Due to a number of factors, including, for example, model inaccuracy, calibration error, and camera exposure variations, misaligned patches and color seams, known as visual artifacts, are often visible in the textured 3D model produced in this way.

While attempts have been made to improve the color and/or texture of textured 3D models, none provides the advantages of the disclosed invention, including robustness to geometric inaccuracy in the model and image-model registration error, memory efficiency and scalability, elimination of the need to parameterize the 3D model or to build a global texture atlas, and the easy addition of new images, as well as improved speed over existing methodologies without sacrificing quality.

In general, the current baseline methodology is to project every triangle on the surface mesh to each image in order to retrieve color. This approach is sufficient when both the calibration and surface geometry are accurate. However, the requisite accuracy is difficult to achieve with low cost scanners, such as the Microsoft Kinect® sensor.

Mitigation of visual artifacts, e.g., texture misalignment, is therefore necessary. Such texture misalignment occurs between adjacent triangles of the polygonal mesh with different input images, as well as at depth boundaries, which can occur with the existing methodologies even if there is only one input image.

One approach for mitigating the visual artifacts is to blend several images near their seams. The different methodologies according to this approach are concerned with the application of blending weights, and how those blending weights are generated. While the blending approach can remove sharp seams efficiently with proper weighting, it leads to ghosting and blurring artifacts when images are misaligned in the overlap areas.

Another approach for mitigating the visual artifacts is to project the model surface onto images and formulate the texturing problem as an image stitching problem. While such image stitching approaches tend to alleviate many artifacts, some seams still remain due to misalignment and geometric inaccuracies. Moreover, methodologies attempting to correct for misalignment have proven to be too time costly and computationally expensive, and are not sufficiently effective.

Alternative techniques are based on a user specifying a number of matching points between the triangle mesh and image region have been proposed, but are similarly flawed, at least in part, due to the required user interaction.

Systems and methods for providing textured 3D models are therefore needed, which do not suffer from the drawbacks of existing methodologies.

### SUMMARY OF THE INVENTION

Systems and methods for the fast texture mapping of 3D models are therefore disclosed, which provide advantages over the existing methodologies.

The invention observes that the aforementioned texture misalignments can always be fixed by shifting the texture coordinates of the impacted triangle. And while prior methodologies for removing texture seams have been developed to solve this texture shift problem in a global optimization framework, the invention recognizes that the texture shift can be first optimized at the texture seams, in parallel on a per triangle basis, and then be consolidated globally over the entire image. The disclosed systems and methods thus provide for 3D model texturing that is an estimated 50 to 100 times faster than existing 3D model texturing methods, without sacrificing the quality of the texture.

In general, a 3D model is textured with a set of calibrated images. A polygon mesh with m triangles {F₁, F₂ . . . Fₘ} is provided. Also provided are n input images {I₁, I₂ . . . Iₙ}. Texture coordinates Tᵢ are determined for each triangle Fᵢ, which texture coordinates are denoted as Tᵢ={lᵢ, tᵢ}, where lᵢϵ{1 . . . n} identifies the source image, and tᵢϵ⁶ identifies the UV coordinates in the selected source image space. A textured 3D model is produced by optimizing the texture coordinates for each triangle {T₁, T₂ . . . Tₘ} such that the resulting textured 3D model is substantially without visible distortions, seams or other artifacts.

The present invention provides a number of benefits and/or advantages over existing methodologies for generating textured 3D models. For example, the inventive methodology reduces visible seams and/or misalignment at texture and/or depth boundaries of generated textured 3D models, correcting texture distortions caused by local movement so as to improve the textured 3D model quality, in particular its appearance, to a level that can be appreciated by average users.

The inventive methodology also achieves good quality textured 3D models up to 100 times faster than existing methodologies—without sacrificing texture quality. Moreover, the inventive methodology is more resilient to modeling and calibration errors, thereby allowing for users relatively untrained in computer-generated-imaging techniques to quickly and fully automatically create textured 3D models using commercially available depth sensors. The inventive methodology therefore makes textured 3D modeling as ubiquitous as taking pictures.

Other features and advantages of the present invention will become apparent from the following more detailed description, taken in conjunction with the accompanying drawings, which illustrate, by way of example, the principles of the presently described embodiments.

### BRIEF DESCRIPTION OF THE DRAWING(S)

FIG. 1 is a schematic diagram of a computer-based system for generating textured 3D models according to at least one embodiment of the present invention;

FIG. 2 is a schematic diagram of a system architecture for generating textured 3D models according to at least one embodiment of the present invention;

FIG. 3 is a flowchart of a method for generating textured 3D models according to at least one embodiment of the present invention.

### DETAILED DESCRIPTION OF THE PREFERRED EMBODIMENTS

The above described drawing figures illustrate the disclosed invention in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspects of the invention to any embodiment illustrated. Therefore, it should be understood that what is illustrated is set forth only for the purposes of example and should not be taken as a limitation on the scope of the disclosed invention.

In the following detailed description and corresponding figures, numerous specific details are set forth in order to provide a thorough understanding of the present invention. However, it should be appreciated that the invention may be practiced without such specific details. Additionally, for brevity sake well-known methods, procedures, components, and circuits have not been described in detail.

In general, the systems and methods disclosed herein are applicable for texturing a 3D model with a set of calibrated images, namely texturing a polygon mesh having m triangles, which may be denoted as Fᵢ={F₁, F₂ . . . Fₘ}, with n input images, which may be denoted as Iᵢ={I₁, I₂ . . . Iₙ}. Texture coordinates Tᵢ are determined for each triangle Fᵢ, which texture coordinates may be denoted as Tᵢ={lᵢ, tᵢ}, where lᵢϵ{1 . . . n} identifies a source image, and tᵢϵR⁶ identifies the UV coordinates in the selected source image space. A textured 3D model is then generated by optimizing the UV coordinates tᵢ for each coordinate Tᵢ={T₁, T₂ . . . Tₘ} such that the generated textured 3D model is substantially without visible distortions, seams or other artifacts.

The methodology of the disclosed invention generally includes two stages. The first stage is to determine source images lᵢ for the texture coordinates Tᵢ. This determination is preferably based on one or more criteria, including the number of visible vertices, viewing angles, and/or smoothness constraints. The second stage is to optimize the texture coordinates Tᵢ, i.e., shifting the texture coordinates of the triangles Fᵢ. The texture shifts are first optimized at texture seams, in parallel and/or on a per triangle basis, and are then consolidated globally over the entire image. Additional details will become apparent from the discussion of the various figures herein.

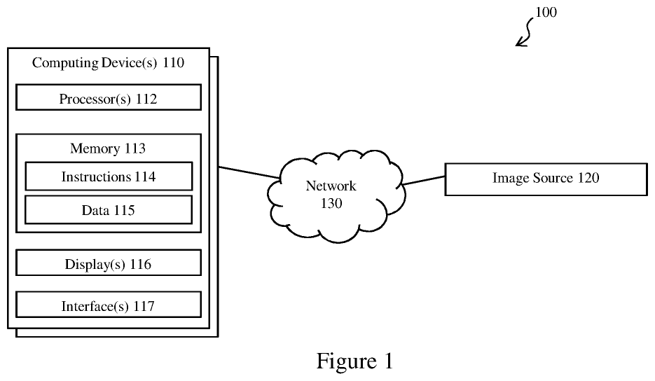

FIG. 1 illustrates an example system 100 in accordance with one or more embodiments. The system may represent at least a portion of a computing environment for generating textured 3D models. The system may include one or more computing devices, such as computing device 110 and an image source 120, communicatively coupled to via a network 130.

The computing devices may include different types of components associated with computing devices, such as one or more processors 112, memory 113, instructions 114, data 115, display 116, and an interface 117. The computing devices may be mobile (e.g., laptop computer, tablet computer, smartphone, PDA, etc.) or stationary (e.g., desktop computer, etc.).

The processor of the computing device may instruct the components thereof to perform various tasks based on the processing of information and/or data that may have been previously stored or have been received, such as instructions and/or data stored in the memory. The processor may be a standard processor, such as a central processing unit (CPU), or may be a dedicated processor, such as an application-specific integrated circuit (ASIC) or a field programmable gate array (FPGA).

The memory of the computing device may store instructions and/or data that can be accessed by the processor. For example, the memory may be hardware capable of storing information accessible by the processor, such as a ROM, RAM, hard-drive, CD-ROM, DVD, write-capable, read-only, etc. The set of instructions may be included in software that can be implemented on the computing device. It should be noted that the terms “instructions,” “steps,” “algorithms,” and “programs” may be used interchangeably. The data can be retrieved, manipulated or stored by the processor in accordance with the set of instructions or other sets of executable instructions. The data may be stored as a collection of data.

The display may be any type of device capable of communicating data to a user, such as a liquid-crystal display (“LCD”) screen, a plasma screen, etc. The interface allows a user to communicate with the computing device, and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface “GUI,” etc.).

The image source may be any type of device capable of generating 3D image data (i.e., data that may be used to generate digital 3D models), such as a 3D scanning device. Exemplary 3D scanning devices include the Microsoft Kinect® and Intel RealSense® systems.

The network may be any type of network, wired or wireless, configured to facilitate the communication and transmission of data, instructions, etc. from one node to another node of the network. For example, the network may be a local area network (LAN) (e.g., Ethernet or other IEEE 802.03 LAN technologies), Wi-Fi (e.g., IEEE 802.11 standards, wide area network (WAN), virtual private network (VPN), global area network (GAN)), any combination thereof, or any other type of network.

It is to be understood that the network configuration illustrated in FIG. 1 serves only as an example and is thus not limited thereto. The system, for instance, may include numerous other components connected to the network, include more than one of each component, and the network may be connected to other networks.

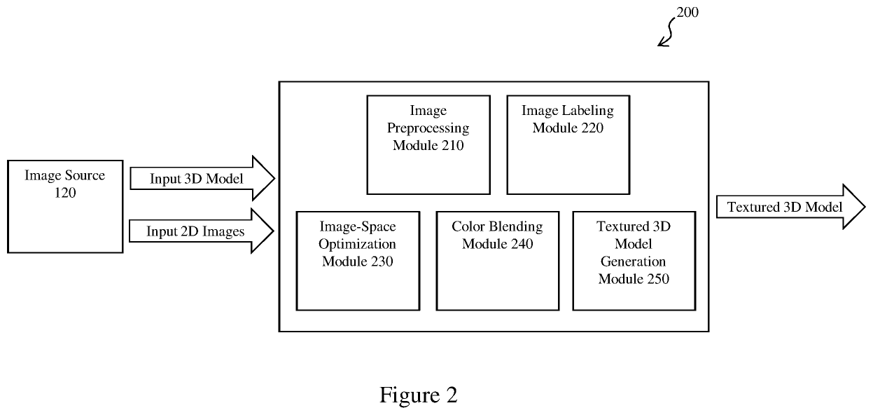

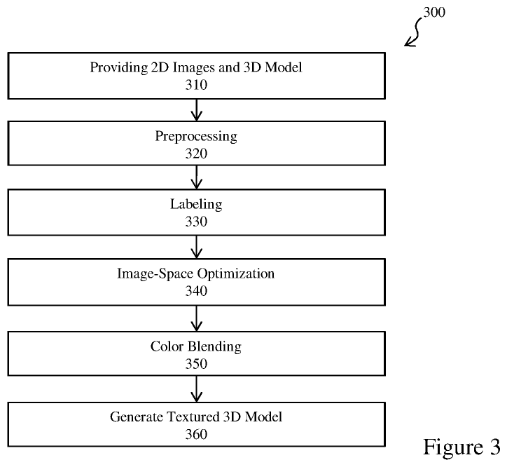

FIG. 2 illustrates an architecture 200 for generating textured 3D models in accordance with one or more embodiments. The architecture comprises the image source, as well as several functional modules, including an image preprocessing module 210, an image labeling module 220, an image-space optimization module 230, a color blending module 240, and a textured 3D model generation module 250. The functionalities of the various modules will be described with reference to FIG. 2, as well as FIG. 3, which illustrates a method 300 for generating textured 3D models in accordance with one or more embodiments.

The texturing source is configured to provide the system with an input 3D model and a plurality of input images associated with the 3D model, as is known in the art. This is done at an input step 310. The input 3D model may be a polygon mesh having m triangles, which may be denoted as Fᵢ={F₁, F₂ . . . Fₘ}. The plurality of input images may be 2D color images, each image being associated with one or more triangles.

The image preprocessing module is configured to determine a source image set by selecting images from the plurality of input images so as to generate the source image set. This is done at a preprocessing step 320. Such selected images are herein referred to as source images. The image preprocessing module preferably selects source images within a greedy selection manner. In accordance with the greedy selection, the preprocessing module counts the number of visible triangles in each input image. If the number of newly visible triangles is above a predetermined threshold, the preprocessing module adds the input image to the source image set as a source image.

The image preprocessing module is also configured to simplify the input 3D model through mesh simplification techniques. This is also done during preprocessing 320. The image preprocessing module preferably simplifies the input 3D model by applying an edge collapse method to the 3D model so as to achieve a proper density. The mesh simplification process is preferably traceable and reversible in accordance with exemplary simplification techniques described in the paper by P. V. Sander, J. Snyder, S. J. Gortler, and H. Hoppe, “Texture mapping progressive meshes,” in Proceedings of the 28th Annual Conference on Computer Graphics and Interactive Techniques (ACM, 2001, pp. 409-416), herein incorporated by reference in its entirety.

The image labeling module is configured to associate each triangle Fᵢ with a corresponding source image lᵢ. This is done at a labeling step 330.

For example, the source image for triangle Fᵢ may be denoted as Iₗ_{ᵢ}, and the optimal label set [symbol] ={l₁, l₂ . . . lₙ} may be obtained when the following cost function is minimized:

$$E ( ℒ ) = {\sum }_{i ∈ F} ( {E}_{d a t a} ( {l}_{i} ) + λ {\sum }_{j ∈ {𝒩}_{{F}_{i}}} {E}_{s m o o t h} ( {l}_{i} , {l}_{j} ) ) , \qquad ( 1 )$$

where E_{data} is the data term indicating the cost of assigning image Iₗ_{ᵢ} to triangle Fᵢ.

Two main factors may be employed in the data term E_{data}: the resolution for triangle Fᵢ in image space, and the angle between the normal of triangle Fᵢ and the view direction for the triangle Fᵢ. This may be formulated as:

E_{data}(lᵢ)=−d(Fᵢ,Iₗ_{ᵢ})a(Fᵢ,Iₗ_{ᵢ}),

where d(Fᵢ, Iₗ_{ᵢ}) denotes the mean distance between triangle Fᵢ and the center of projection for Iₗ_{ᵢ}, and a(Fᵢ, Iₗ_{ᵢ}) denotes the angle between the normal of triangle Fᵢ and the view direction for Fᵢ.

The second part of equation (1) is the smoothness term, where N_{F}_{ᵢ} indicates the 1-ring neighbor of triangle Fᵢ. The pairwise smoothness cost is defined after the Potts Mode

$${E}_{s m o o t h} ( {l}_{i} , {l}_{j} ) = \{ \begin{matrix}0 , & {l}_{i} = {l}_{j} \\ 1 , & {l}_{i} \neq {l}_{j}\end{matrix}$$

in accordance with the principles described in the paper by V. Lempitsky and D. Ivanov, “Seamless mosaicing of image-based texture maps,” 2007 IEEE Conference on Computer Vision and Pattern Recognition (IEEE, 2007, pp. 1-60), herein incorporated by reference in its entirety.

The cost function E(L) in Eq. (1) can be effectively optimized with Graph Cut. However, any known algorithm variation for choosing specific data and smoothness terms may be utilized in accordance with the principles of the invention.

The image-space optimization module is configured to adjust the texture coordinates Tᵢ using local then global optimization techniques. In general, the texture coordinates tᵢϵR⁶ for each triangle Fᵢ may be adjusted within the input image (i.e., texture) space. This is done at an image-space optimization step 340.

Starting from the projective texture coordinates, additional constraints may be added to these values to remove the seams, with the objective to optimize the texture coordinates Tᵢ so as to satisfy all constraints on a per image basis.

The adjustment of the texture coordinates Tᵢ is accomplished via a local optimization process followed by a global optimization process. The color space utilized is preferably RGB, but other color spaces may be utilized without departing from the scope of the invention.

The local optimization process includes optimizing the texture coordinates Tᵢ according to inter-image constraints such that constrained texture coordinates Tᵢ are computed for a given triangle Fᵢ. The local optimization is such that it only depends on the given triangle Fᵢ and its 1-ring neighbor. It will be understood that while the local optimization is determined on a per-triangle basis, all triangles Fᵢ in the current input images may be determined in parallel.

In accordance with the local optimization process, the texture coordinates Tᵢ are constrained by inter-image constraints and intra-image constraints. Inter-image constraints seek to remove misalignments between two different source images. Intra-image constraints seek to remove misalignments within individual source images (e.g., those caused by depth discontinuities).

Referring now to the inter-image constraints, triangles Fᵢ whose neighboring triangles are associated with different source images are subject to the inter-image constraints. The inter-image constraints are such that mismatches between two input images' contents along the shared triangle edges are minimized. A matching cost function can be defined as:

E_{edge}(Fᵢ,Fᵢ)=∫_{F}_{ᵢ}_{∩F}_{ⱼ} [symbol] (Ø_{F}_{ᵢ}^{l}^{ᵢ}(x),Ø_{F}_{ⱼ}^{l}^{ⱼ}(x))dx, (2)

where Ø_{F}_{ᵢ}^{l}^{ᵢ} is a projection operator of Fᵢ onto image Iₗ_{ᵢ}, and [symbol] (Ø_{F}_{ᵢ}^{l}^{ᵢ},Ø_{F}_{ⱼ}^{l}^{ⱼ}(x)) is a distance metric. It will be understood that E_{edge}(Fᵢ, Fᵢ) is zero when Fᵢ and Fⱼ are projected onto the same image, that is, when lᵢ=lⱼ. The distance metric may be defined as the sum of color difference and gradient difference:

[symbol]

(xᵢ,xⱼ)=α∥Iₗ_{ᵢ}(xᵢ)−Iₗ_{ⱼ}(xⱼ)∥+(1−α)∥Gₗ_{ᵢ}(xᵢ)−Gₗ_{ⱼ}(xⱼ)∥, (3)

where xᵢ and xⱼ are the 2D texture coordinates in images lⱼ and lⱼ of one 3D point on the shared edge of corresponding triangles Fⱼ and Fⱼ, respectively, and α is a weighting factor set to 0.9. It will be understood that the weighting factor α may be set to other values without departing from the scope of the invention.

The proper texture coordinates shift, which may be denoted as (Δxᵢ,Δxⱼ), which minimizes E_{edge}(Fᵢ,Fᵢ) is also searched for. The objective function utilized is in the form of:

Eₒₚₜ= [symbol] ∫_{F}_{ᵢ}_{∩F}_{ⱼ}M(Ø_{F}_{ᵢ}^{l}^{ᵢ}(x)+Δxᵢ,Ø_{F}_{ⱼ}^{l}^{ⱼ}(x)+Δxⱼ)dx, (4)

where [symbol] is a texture movement indicator, which is used to penalize unnecessary movement caused color space noise and same translation along the edge. It may be defined as:

[symbol]

=(1+∥Δxᵢ∥²)(1+∥Δxⱼ∥²). (5)

A greedy search of all the ∥Δx∥>Δxₘₐₓ may be used to optimize equation (4). However, it is preferably to use a random line search on xᵢ and xⱼ.

After minimizing equation (4), an inter-image constraint \tilde{t}ᵢ for the UV coordinate tᵢ may be set to:

\tilde{t}ᵢ=tᵢ+Δxᵢ.

A corresponding constraint weight ω may also be set to:

ω=ΔEₒₚₜ/Eₒₚₜ.

It will be understood that while the inter-image constraint is solved on a per-triangle basis, all triangles in the current input images may be solved in parallel.

Referring now to intra-image constraints, triangles Fᵢ with inconsistencies between depth boundaries and color edges are subject to the intra-image constraints. Accordingly, potential intra-image misalignment may be initially determined by applying edge detection techniques to both the color image and the synthetic depth map that is generated by projecting the 3D model onto the image.

Any triangle that (a) is determined to have at least one edge on the depth boundaries and (b) is determined to be close to a color edge within the threshold of υ=20 pixels, is marked as a candidate for the application of the intra-image constraint.

In determining the intra-image constraints, the 2D texture coordinate in image space of two endpoints of one triangle edge on the depth boundary may be denoted as ρ₀ and ρ₁. Both endpoints may be adjusted along the normal direction of \vec{ρ₀ρ₁} until they intersect a color edge, where new texture coordinates are recorded as ρ′₀ and ρ′₁. Thus, ρ′₀ and ρ′₁ form an intra-image constraint for ρ₀ and ρ₁, respectively. The corresponding constraint weights may be set to be inversely proportional to the distance as:

$$ω = exp ( - \frac{{‖ {ρ}_{0} - {ρ}_{0}^{′} ‖}^{2} + {‖ {ρ}_{1} - {ρ}_{1}^{′} ‖}^{2}}{2 {Ø}^{2}} ) ,$$

where Ø is a weighting factor set to 4.0. It will be understood that the weighting factor Ø may be set to other values without departing from the scope of the invention.

The global optimization process includes optimizing the texture coordinates Tᵢ of the 3D model in each image to satisfy, as much as possible, all the constraints, as well as the original texture coordinates Tᵢ.

Global optimization is performed in one image at one time. Therefore, all the texture coordinates may be denoted as: T={t₁, t₂ . . . tₙ}. The cost function for the global optimization is accordingly:

$$E ( \tilde{T} ) = \frac{λ}{2} {‖ L \tilde{T} - ρ ‖}_{F}^{2} + {\sum }_{k} {C}_{k} ( \tilde{T} , {T}_{k} ) \qquad ( 6 )$$

where L is the Laplacian matrix using the cotangent weight, and ρ=∀²(T) is the divergence of original projective texture coordinates gradient, and λ is a user-defined weighting factor. The user-defined weighting factor is preferably set to 0.5, but other values may be used without departing from the scope of the invention.

The first term in equation (6) requires that the new texture coordinates \tilde{T} be similar to the original texture coordinates T. The second term: Cₖ(\tilde{T},Tₖ), is an additional global constraint. The subscript k differentiates between different types of constraints. In general, a global constraint has the form of:

$${C}_{k} ( \tilde{T} , {T}_{k} ) = \frac{{ω}_{k}}{2} {‖ {A}_{k} {S}_{k} \tilde{T} - {B}_{k} {T}_{k} ‖}_{F}^{2} , \qquad ( 7 )$$

where Tₖ is an auxiliary variable representing the expected texture coordinates under the current constraint. It will be understood that not all texture coordinates have constraints. For those texture coordinates that are not subject to a constraint k, their values in Tₖ will be zero. The elements Aₖ and Bₖ are weighting matrices for Tₖ, which are updated in every iteration to indicate the confidence for the current computed Tₖ. The element Sₖ is a selection matrix, which is a diagonal matrix whose diagonal elements are 1 if the corresponding texture coordinates in Tₖ are not 0, and whose diagonal elements are otherwise 0. The element ωₖ is a non-negative weight balancing different constraints.

Equation (6) is solved in an iterative fashion. First, \tilde{T} is fixed, and each constraint is solved for its own set of auxiliary variables T_{c}. This minimization can be performed independently and in parallel. Then, the entire cost function is optimized by incorporating in the fixed Tⱼ, which results in the following linear system:

λL^{T}L+ΣⱼωⱼSⱼ^{T}Aⱼ^{T}AⱼSⱼ\tilde{T}=λL^{T}ρ+ΣⱼωⱼSⱼ^{T}Aⱼ^{T}AⱼBⱼTⱼ. (8)

Equation (8) is a sparse system, which can be solved using any standard sparse solver. It will be understood that, since the texture coordinates are solved on a per-triangle basis, a single vertex may have different texture coordinates. To ensure texture continuity within an input image, additional equations are added to the linear system to constrain all the texture coordinates for the same vertex to be equal.

The iterative solution may be understood in terms of the execution of the following computer algorithm:

Algorithm 1 Texture Solver

| | |
|---|---|
| 1: | loop sloverIteration times |
| 2: | if sloverIteration == 1 then |
| 3: | T ← initialvalue |
| 4: | else |
| 5: | T ← \tilde{T} |
| 6: | end if |
| 7: | for all constraints j do |
| 8: | Tⱼ = ConstraintCalculate(Cⱼ, T) (In parallel) |
| 9: | end for |
| 10: | \tilde{T} = SolveLinearSystem(T, T₀, T₁ ,T₂, . . . Tⱼ) |
| 11: | end loop |

The initial value of T is computed using the projective mapping and image labeling principles described herein. Notably, this means that L only needs to be determined once within the iterative process. Moreover, 1 and 3 iterations are sufficient to solve for one image. After one image is solved, the process is executed on the next image until all the triangles have their optimized texture coordinates.

The color blending module is configured to correct for color difference between image boundaries via use of a global color adjustment followed by a local Poisson Blending, which techniques are individually known in the art. Exemplary techniques are described in V. Lempitsky and D. Ivanov, “Seamless mosaicing of image-based texture maps,” in 2007 IEEE Conference on Computer Vision and Pattern Recognition (IEEE, 2007, pp. 1-6), and P. P'erez, M. Gangnet, and A. Blake, “Poisson image editing,” in ACM Transactions on Graphics (TOG), vol. 22, no. 3 (ACM, 2003, pp. 313-318). This is done at a color blending step 350.

The textured 3D model generation module 250 thereafter generates the textured 3D model based on the optimized texture coordinates and the associated color blended images. This is done at step 360. Accordingly, textured 3D models may be more quickly and efficiently generated than with prior methodologies, while having improved image characteristics, including substantially lessened or eliminated misalignments. The textured 3D models may be saved to the memory of the computing device and accessed by a user through the input/output device, such as the GUI, and/or may be communicated to another computing device for further use.

The inventor's work entitled “Fast Texture Mapping Adjustment via Local/Global Optimization” is published in the IEEE Transactions on Visualization and Computer Graphics, and is hereby incorporated by reference in its entirety.

The embodiments described in detail above are considered novel over the prior art of record and are considered critical to the operation of at least one aspect of the invention and to the achievement of the objectives of the invention. The words used in this specification to describe the exemplary embodiments are to be understood not only in the sense of their commonly defined meanings, but also to include any special definition with regard to structure, material or acts that would be understood by one of ordinary skilled in the art to apply in the context of the entire disclosure.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment.

Furthermore, the particular features, structures, or characteristics may be combined in any suitable manner on one or more embodiments without limitation. The term “or” as used herein is to be interpreted as inclusive or meaning any one or any combination.

The definitions of the words or drawing elements described herein are also meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim without departing from the scope of the invention.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In accordance with the practices of persons skilled in the art, the invention is described herein with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

Accordingly, the functionalities described herein may be implemented via hardware, software, firmware or any combination thereof, unless expressly indicated otherwise. If implemented in software, the functionalities may be stored in a memory as one or more instructions on a non-transitory computer readable medium, including any available media accessible by a computer that can be used to store desired program code in the form of instructions, data structures or the like. Thus, certain aspects may comprise a computer program product for performing the operations presented herein, such computer program product comprising a non-transitory computer readable medium having instructions stored thereon, the instructions being executable by one or more processors to perform the operations described herein. It will be appreciated that software or instructions may also be transmitted over a transmission medium, as is known in the art. Further, software and/or hardware modules and/or other appropriate means for performing the operations described herein may be utilized in implementing the functionalities described herein.

The scope of this description is to be interpreted in conjunction with the appended claims.

What is claimed is:

1. A method for texturing an un-textured computer-generated 3D model that is a polygon mesh of a plurality of triangles, the method comprising:
providing a set of input images and the un-textured 3D model;
determining texture coordinates for each triangle of the polygon mesh, each texture coordinate associating the triangle with an area of a source image from the set of input images, wherein determining the texture coordinates includes:
locally optimizing the texture coordinates along texture seams, and
subsequently, globally optimizing the texture coordinates in each source image over the entire source image; and
generating a textured 3D model from the determined texture coordinates.

2. The method of claim 1, wherein local optimization includes optimization according to inter-image constraints, which correct for mismatches between respective input image contents along shared edges of adjacent triangles.

3. The method of claim 2, wherein, for each triangle, local optimization according to inter-image constraints is based solely on the triangle and its 1-ring neighbors.

4. The method of claim 2, wherein only triangles whose 1-ring neighbors are associated with different source images are subject to the inter-image constraints.

5. The method of claim 1, wherein the local optimization includes optimization according to intra-image constraints, which correct for inconsistencies between depth boundaries and color edges.

6. The method of claim 1, further comprising:
preprocessing the set of input images so as to determine a set of source images, wherein the source image is from the set of source images.

7. The method of claim 1, further comprising:
determining initial texture coordinates for each triangle of the polygon mesh, each initial texture coordinate associating the triangle with the source image and an initial area of the source image,
wherein the texture coordinates of at least one triangle are adjusted from the initial texture coordinates of the at least one triangle.

8. The method of claim 1, further comprising:
color blending each of the triangles.

9. A system for texturing an un-textured computer-generated 3D model that is a polygon mesh of a plurality of triangles, the method comprising:
an image source configured to provide a set of input images and the un-textured 3D model;
an image space optimization module configured to determine texture coordinates for each triangle of the polygon mesh, each texture coordinate associating the triangle with an area of a source image from the set of input images, wherein determining the texture coordinates includes:
locally optimizing the texture coordinates along texture seams, and
subsequently, globally optimizing the texture coordinates in each source image over the entire source image; and
a textured 3D model generation module configured to generate a textured graphical 3D model from the determined texture coordinates.

10. The system of claim 9, wherein local optimization includes optimization according to inter-image constraints, which correct for mismatches between respective input image contents along shared edges of adjacent triangles.

11. The system of claim 10, wherein, for each triangle, local optimization according to inter-image constraints is based solely on the triangle and its 1-ring neighbors.

12. The system of claim 10, wherein only triangles whose 1-ring neighbors are associated with different source images are subject to the inter-image constraints.

13. The system of claim 9, wherein the local optimization includes optimization according to intra-image constraints, which correct for inconsistencies between depth boundaries and color edges.

14. The system of claim 9, further comprising:
a preprocessing module configured to preprocess the set of input images so as to determine a set of source images, wherein the source image is from the set of source images.

15. The system of claim 9, further comprising:
a preprocessing module configured to determine initial texture coordinates for each triangle of the polygon mesh, each initial texture coordinate associating the triangle with the source image and an initial area of the source image,
wherein the texture coordinates of at least one triangle are adjusted from the initial texture coordinates of the at least one triangle.

16. The method of claim 9, further comprising:
a color blending module configured to color blend each of the triangles.

17. A non-transitory computer readable medium having processor executable instructions, which, when executed by a processor, cause the performance of a method for texturing an un-textured computer-generated 3D model that is a polygon mesh of a plurality of triangles, the method comprising:
receiving a set of input images and the un-textured 3D model;
determining texture coordinates for each triangle of the polygon mesh, each texture coordinate associating the triangle with an area of a source image from the set of input images, wherein determining the texture coordinates includes:
locally optimizing the texture coordinates along texture seams, and
subsequently, globally optimizing the texture coordinates in each source image over the entire source image; and
generating a textured 3D model from the determined texture coordinates.

18. The non-transitory computer readable medium of claim 17, wherein local optimization includes optimization according to inter-image constraints, which correct for mismatches between respective input image contents along shared edges of adjacent triangles.

19. The non-transitory computer readable medium of claim 17, wherein the local optimization includes optimization according to intra-image constraints, which correct for inconsistencies between depth boundaries and color edges.

20. The non-transitory computer readable medium of claim 17, further comprising instructions for:
determining initial texture coordinates for each triangle of the polygon mesh, each initial texture coordinate associating the triangle with the source image and an initial area of the source image,
wherein the texture coordinates of at least one triangle are adjusted from the initial texture coordinates of the at least one triangle.
